(19) United States
(12) Patent Application Publication
(10) Pub. No.: US 2004/0075536 A1
(43) Pub. Date: Apr. 22, 2004

(54) Handle with sound and light effects

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/201,691

(22) Filed: Jul. 24, 2002

(51) Int. Cl. G08B 27/00

(52) U.S. Cl. 340/326; 475/326

(57) ABSTRACT

A handle provided with sound and light effects by having a chamber in the middle of the handle to contain a generator unit and a sound device linked to the handle; one end of the handle containing a turning gear to drive a transmission gear set; a holder containing an induction coil connected to light emitting devices and a ring magnet penetrating by a shaft with both ends of the shaft formed with a driven gear to be engaged with the transmission gear set for the generator unit; the sound device disposed in relation to the turning gear gives sound whenever it is hit; the handle is turned to synchronously drive the generator unit for both of the ring magnet and the induction coil to rotate in relation to each other for generating power to turn on the light emitting devices, and to drive the turning gear to hit the sound device to give light and sound effects to the handle for adding more fun to the riding.

### BACKGROUND OF THE INVENTION

1. (a) Field of the Invention

The present invention relates to a handle with sound and light effects, and more particularly to, one that creates sound and light effects as it is turned.

2. (b) Description of the Prior Art:

A handle to a bike, a scooter, a tricycle or other wheeled riding toys for children, usually is monotonous since it is provided only to be held for the control of the advancing direction. The handle of the prior art is not given any decoration function. To its best, only a tassel or a terry is given to the handle to attract the attention of the children to add some riding fun. However, handles to riding toys for children generally available in the market are basically lacking in creativity and visual varieties to attract the consumer, thus are extremely acceptable in the market.

### SUMMARY OF THE INVENTION

The primary purpose of the present invention is to provide a handle with sound and light effects given at the same time of riding. To achieve the purpose, a hollow chamber is provided in the center of the handle to contain a transmission gear set, a generator unit and a sound device linked to the handle. The generator unit driven by the transmission gear set includes an induction coil and a ring magnet, and the power is generated as both of the ring magnet and the induction coil rotate in relation to each other.

The distal ends of the chamber are respectively provided with a handle, a transmission gear engaged with the transmission gear set is provided to an end of either handle, the circumference of said transmission gear interconnects with light emitting devices so to hit it while said transmission gear keeps turning.

The transmission gear set includes a driving gear and a plurality of turning gear sets, the driving gear set is held in a positioning rib to be driven when the handle is turned through the plurality of turning gear sets, and the momentum from the handle is transmitted to the generator unit to generate electric power.

The generator unit includes a holder, the induction coil and the ring magnet; the induction coil in the holder is interconnected with the light emitting devices and is fixed to positioning ribs at the base of the holder while the ring magnet disposed in the center of the induction coil is penetrated by a shaft with both ends of the shaft exposed out of the holder to form a driven gear in relation with the turning gear sets of the transmission gear set to engage with the transmission gear sets.

The sound device is one that sounds when it is hit.

When both handles are turned, the transmission gear synchronously drives the transmission gear set to drive the generator unit for both of the ring magnet and the induction coil to relatively turn to turn on the light emitting devices; meanwhile, the turning gear contacts and hits the sound device to give sound. Accordingly, the frame gives sound and light effects whenever both handles are turned to add more riding fun for the rider.

### BRIEF DESCRIPTION OF THE DRAWINGS

FIG. 1 is an exploded view of a preferred embodiment of the present invention.

FIG. 2 is a side view showing that an operation status of preferred embodiment of the present invention.

FIG. 3 is a cross-sectional view of an assembly of the preferred embodiment of the present invention.

FIG. 4 is a view showing that the preferred embodiment of the present invention is in operation.

FIG. 5 is a view of another preferred embodiment of the present invention.

### DETAILED DESCRIPTION OF THE PREFERRED EMBODIMENTS

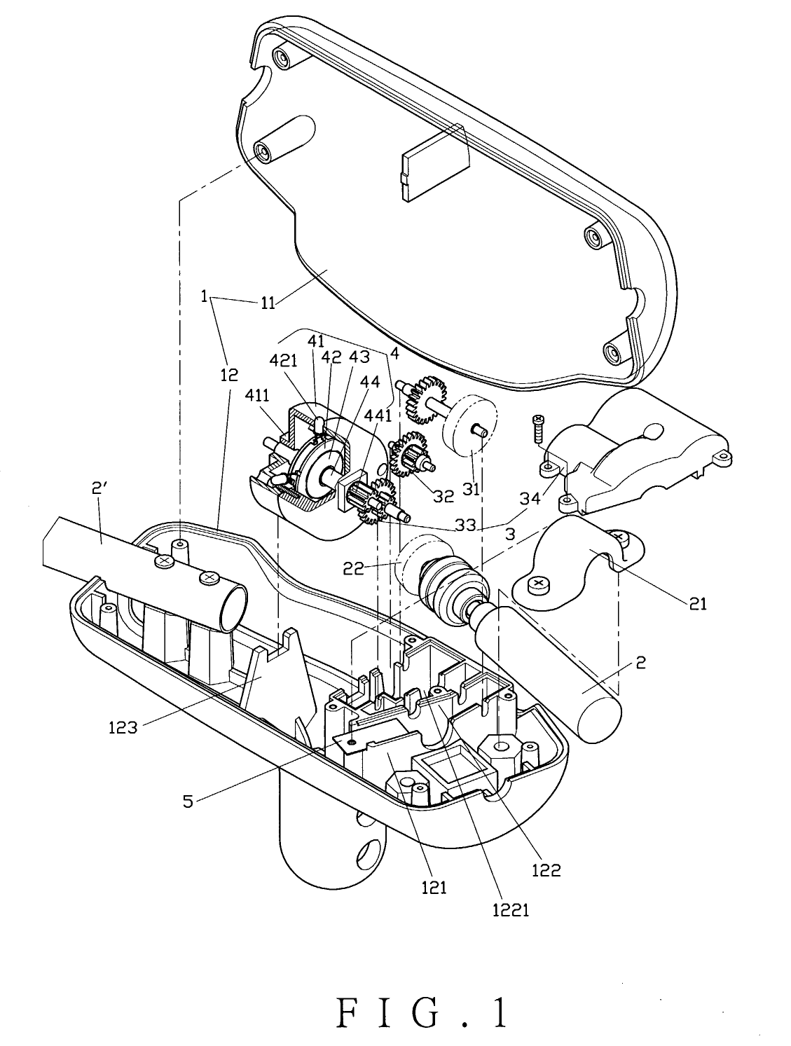

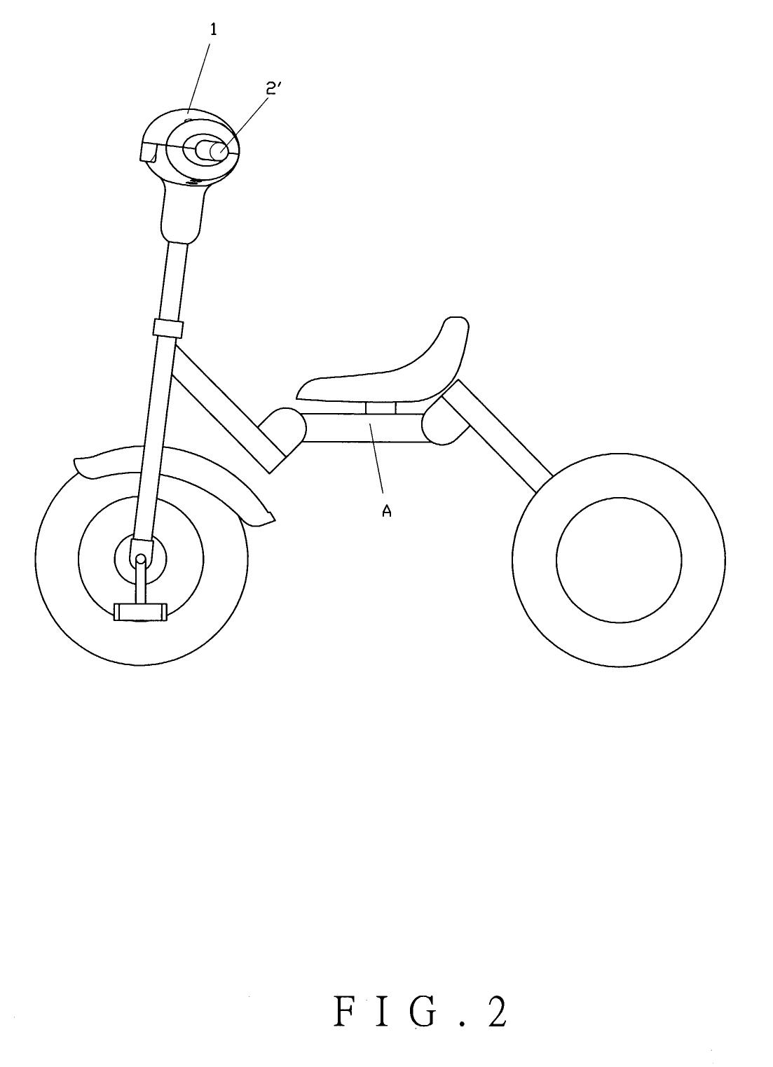

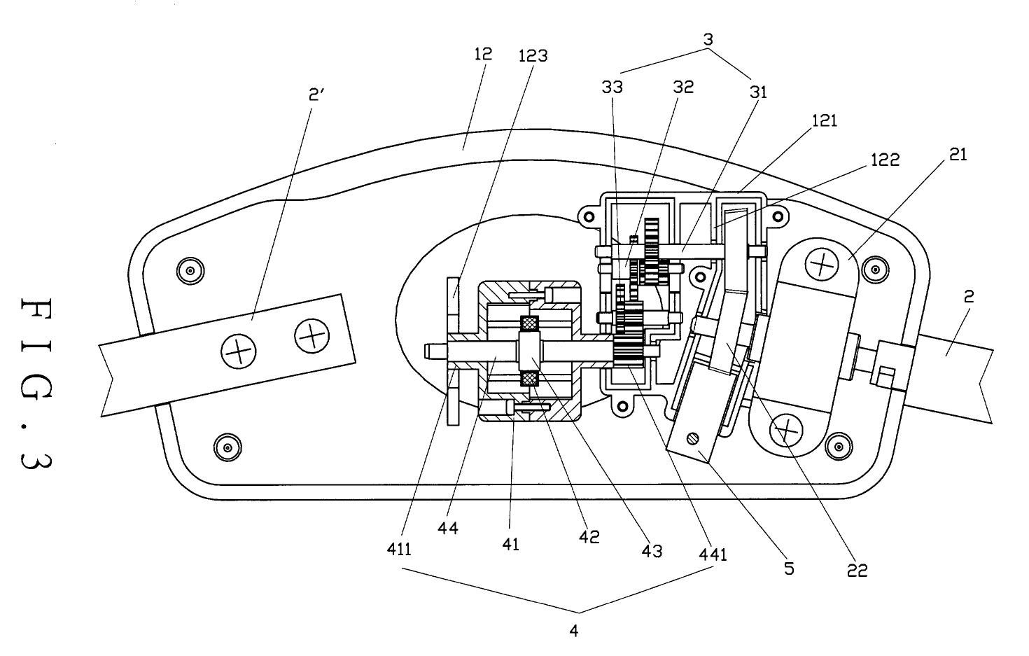

Referring to FIGS. 1, 2, and 3, a preferred embodiment of the present invention is essentially comprised of having provided a chamber (1) at the center of a handle of a frame (A) of a bike. The chamber (1) contains a transmission gear set (3), a generator unit (4) and a sound device (5) linked to a pair of handles (2, 2′). The generator unit (4) includes a holder (41) containing an induction coil (42) and a ring magnet (43). The power is generated by having both of the ring magnet (43) and the induction coil (42) to rotate in relation to each other.

The chamber (1) defines its inner space by a see-through cover (11) and a base (12). Two handles (2, 2′) are respectively provided at both ends of the holder (1). The handle (2) is held by a clamp (21) but is free to turn. A partition (121) is formed exclusively on the base (12) close to the handle (2) and a plurality of positioning ribs (122) is provided in the segregation. A sliding channel (1221) is provided respectively on the positioning rib (122) and the wall of the partition (121). Another positioning rib (123) is separately formed outside the partition (121) in relation to the positioning rib (122) so to support members of the handle (2), the transmission gear set (3) and the generator unit (4).

The transmission gear set (3) is essentially comprised of a driving gear set (31), two turning gear sets (32, 33) and a case cover (34). Axels respectively of the driving gear set (31) and two turning gear sets (32, 33) are provided on the positioning rib (122); all said gear sets (31, 32, 33) are held in position on the base (12) by the case cover (34) while the driving gear set (31) is driven by a turning gear (22) provided at one end of the handle (2) with the momentum created by turning the handle (2) to be transmitted through the two units of gear sets (32, 33) to the generator unit (4).

The generator unit (4) includes the holder (41), the induction coil (42) and the ring magnet. The holder (41) is defined by two cases inserted into each other containing ribs to fix the induction coil (42) for the induction coil (42) to rotate in relation to the holder (41). The induction coil (42) is interconnected with light emitting devices (421) thus to expose out of the circumference of the holder (41) while a fixation end (411) in rectangular is respectively formed on both ends of the holder (41) to be retained in position by the positioning ribs (122, 123) on the base (12), thus to maintain in stationary status. Furthermore, a shaft (44) axially penetrates through the ring magnet (43) in the center of the induction coil (42) with both ends of the shaft (44) to expose out of the holder (41), whereon at the end in relation to the transmission gear set (3) is provided with a driven gear (441) to be engaged with and driven by the transmission gear set (3) for the ring magnet (43) disposed on the shaft (44) to rotate in relation to the induction coil (42).

The sound device (5) is an object, e.g. a bell or a drum, made of metal in sheet or in column to give loud sound, and is provided relatively to the circumference of the turning gear (22). In the preferred embodiment of the present invention, the sound device is made of a sheet metal.

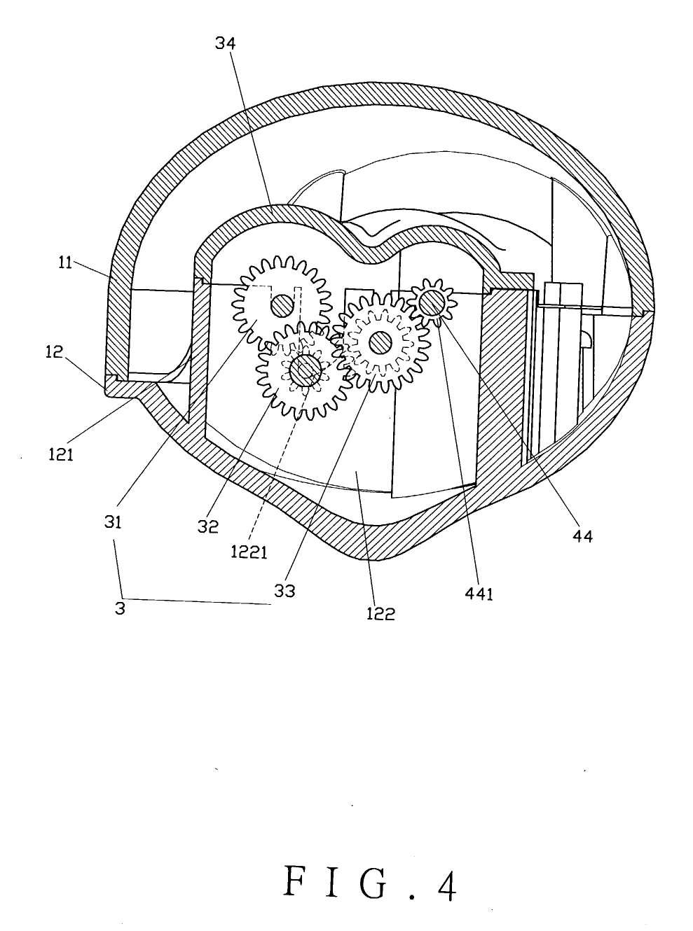

Upon riding as illustrated in FIG. 4, the handle (2) is turned for the turning gear (22) disposed at the end of the handle to synchronously drive the transmission gear set (3), thus for the driving gear set (31) of the transmission gear set (3) to further drive the two turning gear sets (32, 33), so to further drive the ring magnet (43) to rotate in relation to the induction coil (42) by means of the driven gear (441) on the shaft (44). The induction coil (42) generates electric power based on electromagnetic induction principle to turn on the light emitting device (421) provided on the circumference of the holder (41). Whenever the handle (2) is turned, the teeth of the turning gear (22) hit the sound device (5) in sequence for the sound device (5) to give sound. Whereas the axle of the turning gear set (32) is freely disposed in the sliding channel (1221) of the positioning rib (122), a continuously acting force inside the transmission gear set (3) will not affect the turning gear (22) of the handle (2) even the handle (2) is instantaneously stopped turning; therefore, with the handle (2) is instantaneously stopped or turned in reverse, the turning gear set (33) clears away from the otherwise engaged status with another turning gear set (32), resulting in that the turning gear set (32) moves upward along the sliding channel (1221) to clear away from its engagement with the driving gear set (31) and the turning gear set (32) until the turning gear (22) rotates once again by compromising the orientation of the gear, then the driving gear set (31) is driven to descend and return to its engagement status with turning gear set (32). Consequently, the turning gear set (32) is once again engaged with the turning gear set (33) to drive the driven gear (441) disposed at the end of the shaft (44).

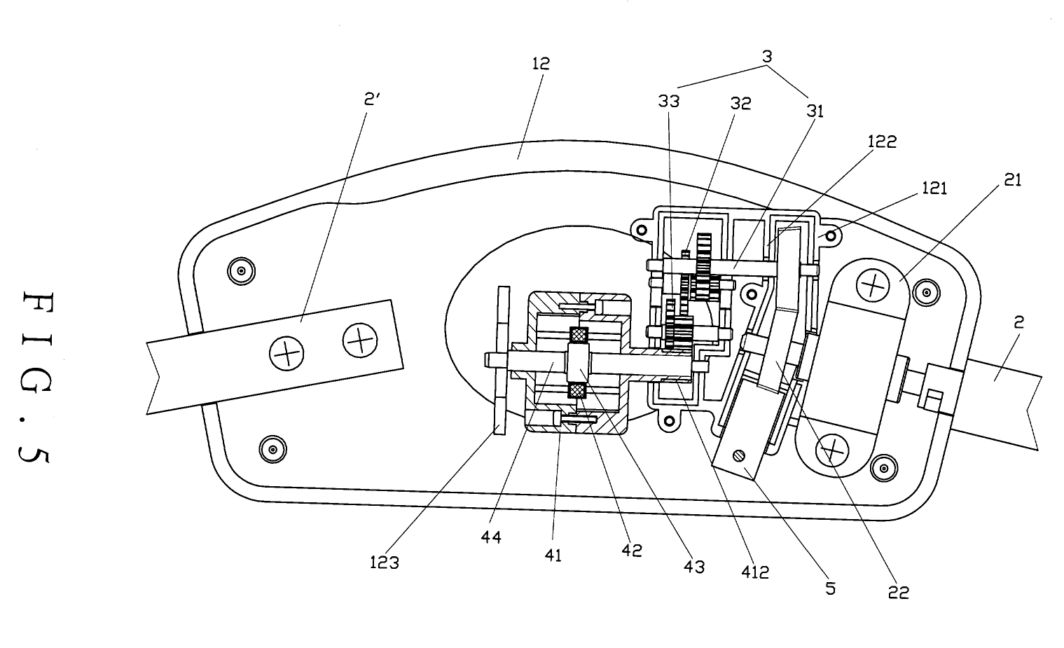

FIG. 5 shows another preferred embodiment of the present invention. Both ends of the shaft (44) penetrating through the ring magnet (43) are respectively fixed at the positioning rib (122) on the base (12) to attain the same power generation result by the turning of the holder (41). With one end of the shaft (44) being fixed to the positioning rib (122), the end of the holder (41) is formed a driven gear (412) in relation to the transmission gear set (3) to merely engage with the transmission gear set (3). Once the handle (2) is turned, the transmission gear set (3) is driven by means of the turning gear (22) for the driving gear set (31) at the front end of the transmission gear set (3) to forthwith drive the driven gear (412) disposed at the end of the holder (41), thus further for the induction coil (42) in the holder (41) to rotate in relation to the ring magnet (43) laterally penetrating the center of the induction coil (42) to generate power.

I claim,

1. A structure of a handle with sound and light effects comprising a chamber in the center of the handle in the head of a riding frame; the chamber containing a transmission gear set, a generator unit and a sound device liked to the handle; the generator unit containing an induction coil and a ring magnet to be driven by the transmission gear set and generating power by relative rotation between the ring magnet and the induction coil, characterized by that
two handles being respectively provided to both ends of the chamber; one handle having at its one end disposed of a turning gear engaged with the transmission gear set with the circumference of the turning gear to contact the sound device for the sound device to give sound when hit by the turning gear;
the transmission gear set including a driving gear set and a plurality of turning gear sets; the driving gear set being held in a positioning rib to be driven when the handle is turned through the plurality of turning gear sets; and the momentum from the handle being transmitted to the generator unit to generate electric power;
the generator unit including a holder, the induction coil and the ring magnet; the holder containing the induction coil being interconnected with light emitting devices and being fixed to the positioning rib on the base; the ring magnet being disposed in the center of the induction coil and penetrated axially by a shaft; both ends of the shaft being exposed out of the holder to form a driven gear that is engaged with the transmission gear set in relation to the turning gear sets of the transmission gear set; and
the sound device is a device that gives sound when hit;
the handle being turned to synchronously drive the transmission gear set with the turning gear to further drive the generator unit; thus further to drive both of the ring magnet and the induction gear to rotate in relation to each other to generate power to turn on the light emitting devices while the turning gear hits the sound device to give sound so that when the handle is turned, it gives the sound and light effects at the same time to add more fun to the riding.

2. A structure of a handle with sound and light effects as claimed in claim 1, wherein the sound device is a bell, a drum or a metallic sheet or column object that gives loud sound.

3. A structure of a handle with sound and light effects as claimed in claim 1, wherein the end of the shaft is fixed to the positioning rib, and is formed a driven gear to be engaged to the transmission gear set; the driven gear from the holder being linked as driven by the transmission gear set when the handle is turned for the induction coil to rotate in relation to the ring magnet inside the holder to generate power.
